(19) United States
(12) Patent Application Publication
(10) Pub. No.: US 2009/0321663 A1
(43) Pub. Date: Dec. 31, 2009

(54) Radiation-blocking bladder apparatus and method

(76) Inventor: Barrett H. Moore, Winnetka, IL (US)

Correspondence Address: FITCH EVEN TABIN & FLANNERY, 120 SOUTH LASALLE STREET, SUITE 1600, CHICAGO, IL, 60603-3406, US

(21) Appl. No.: 11/425,043

(22) Filed: Jun. 19, 2006

Related U.S. Application Data
(63) Continuation-in-part of application No. 11/384,037, filed on Mar. 17, 2006.
Application No. 11/384,037 is a continuation-in-part of application No. 11/394,350, filed on Mar. 30, 2006.
Application No. 11/394,350 is a continuation-in-part of application No. 11/279,333, filed on Apr. 11, 2006.
Application No. 11/279,333 is a continuation-in-part of application No. 11/379,929, filed on Apr. 24, 2006, now abandoned.
Application No. 11/379,929 is a continuation-in-part of application No. 11/381,247, filed on May 2, 2006.
Application No. 11/381,247 is a continuation-in-part of application No. 11/381,257, filed on May 2, 2006.
Application No. 11/381,257 is a continuation-in-part of application No. 11/381,265, filed on May 2, 2006, now abandoned.
Application No. 11/381,265 is a continuation-in-part of application No. 11/381,277, filed on May 2, 2006.
Application No. 11/381,277 is a continuation-in-part of application No. 11/420,594, filed on May 26, 2006.

(51) Int. Cl. G01T 1/02; G21F 3/00; B65B 3/04

(52) U.S. Cl. 250/472.1; 250/519.1; 141/10

(57) ABSTRACT

Measurements are provided (101) as correspond to a floor (201) of a room. This room will typically have space thereunder of sufficient size to accommodate a least one person therein. These measurements are used (102) to provide a bladder (202) that will, when at least substantially filled with liquid, substantially fully cover the floor and provide a radiation barrier to thereby provide corresponding protection to a person in the space under that room. The bladder can have one or more openings (203) to facilitate introducing liquid into the bladder and/or to facilitate removing such liquid when desired. Pumps (608) and/or valves (603) can be utilized, if desired, to facilitate such filling and/or emptying. By one approach, one or more supplemental retrofitable supports (701) can be used in the space beneath the room to provide supplemental vertical support to thereby aid in supporting the weight of the bladder when filled.

### RELATED APPLICATIONS

This application comprises a continuation-in-part of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265; and

SUBSCRIPTION-BASED CATASTROPHE-TRIGGERED RESCUE SERVICES FACILITATION METHOD AND APPARATUS as filed on May 2, 2006 and having application Ser. No. 11/381,277;

RESCUE CONTAINER METHOD AND APPARATUS as filed on May 26, 2006 and having application Ser. No. 11/420,594;

the contents of which are fully incorporated herein by this reference.

### TECHNICAL FIELD

This invention relates generally to radiation blockage.

### BACKGROUND

As powerful as the machinery of modern life appears, modern citizens are today perhaps more at risk of experiencing a serious disruption in their ability to prosper or even to survive en mass than is generally perceived. Genuine concerns exist, for example, regarding the threat of ionizing radiation (due, for example, to radioactive fallout created by an intentionally detonated nuclear device or as may result through inadvertence or accident).

Many people believe and trust that their government (local, regional, and/or national) will provide for them in the event of such an event. And, indeed, in the long view such is clearly a legitimate responsibility owed by any government to its citizens. That such is a consummation devoutly to be wished, however, does not necessarily make it so. To a large extent one may reasonably argue that governments have forsaken their responsibility to design, fund, implement, or even discuss an effective program capable of protecting large segments of their populations. Only a very few countries, such as Switzerland, make the ability to survive such events a well-discussed, funded, regulated, and supported part of the civil fabric.

It is possible, of course, to retain the services of skilled providers of radiation shelters. Such an approach, however, presents a number of corresponding problems and issues. In general, such shelters require excavation and the building of a below-ground facility. This, in turn, tends to be costly and may cause considerable unwanted attention. In particular, the person or family who takes such an action often has a wish for at least some degree of confidentiality and discretion in this regard. Between the highly noticeable activities that characterize the building of such a shelter, however, and the regulatory and permit requirements and oversight that will often attend such activities, the building and existence of such a shelter will, more often than not, be well known and thereafter comprise easily accessible public information.

Building such a shelter, of course, requires corresponding land. In many cases, however, interested persons may themselves own insufficient land to permit such activity. In many cases, in fact, the interested party may not own any land whatsoever. As already noted above, such a shelter typically represents considerable expense. In many cases this expense may well exceed the capacity of many interested persons to pursue such a course of action.

### BRIEF DESCRIPTION OF THE DRAWINGS

The above needs are at least partially met through provision of the radiation blocking bladder apparatus and method described in the following detailed description, particularly when studied in conjunction with the drawings, wherein:

FIG. 1 comprises a flow diagram as configured in accordance with various embodiments of the invention;

FIG. 2 comprises a schematic perspective view as configured in accordance with various embodiments of the invention;

FIG. 3 comprises a side elevational detail view as configured in accordance with various embodiments of the invention;

FIG. 4 comprises a side elevational detail view as configured in accordance with various embodiments of the invention;

FIG. 5 comprises a side elevational detail view as configured in accordance with various embodiments of the invention;

FIG. 6 comprises a side elevational schematic view as configured in accordance with various embodiments of the invention; and

FIG. 7 comprises a side elevational schematic view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, measurements are provided as correspond to a floor of a particular room. This room, in turn, will typically have space thereunder (as in a basement or lower room in a multi-story structure) of sufficient size and configuration to accommodate a least one person therein. These measurements are then used to provide a corresponding bladder that will, when at least substantially filled with liquid, substantially fully cover the floor and provide a radiation barrier to thereby provide corresponding protection to a person in the space under that room.

The bladder can have a depth as corresponds to a desired degree of radiation blockage capability and/or structural requirements or limitations as pertain to the building that contains the room. By one approach the bladder can have one or more openings to facilitate introducing liquid (such as water) into the bladder and/or to facilitate removing such liquid when desired. Pumps and/or valves can be utilized, if desired, to facilitate such filling and/or emptying. By one approach, one or more supplemental retrofitable supports can be used in the space beneath the room to provide supplemental vertical support to thereby aid in supporting the weight of the bladder when filled.

Such a bladder (when empty) can be relatively light and of reasonable size. This, in turn, can facilitate and permit ready storage, portage, and deployment of such a bladder by a single average adult human. Accordingly, this bladder can be delivered, unloaded, and moved into position without necessarily attracting considerable undue attention. There need be nothing, in fact, to signal to either neighbors or governmental entities that a deployable radiation shelter now exits at a given address.

Accordingly, these teachings permit an economically feasible, retrofittable, highly customizable, and effective radiation shelter to be discretely provided in deployable form to persons seeking the security of such a capability. Although such a shelter may not provide a same degree of radiation blockage as a well-designed and built fallout shelter of more traditional design, the protection offered is nevertheless very real and comprises a viable option when considering many current potential need scenarios.

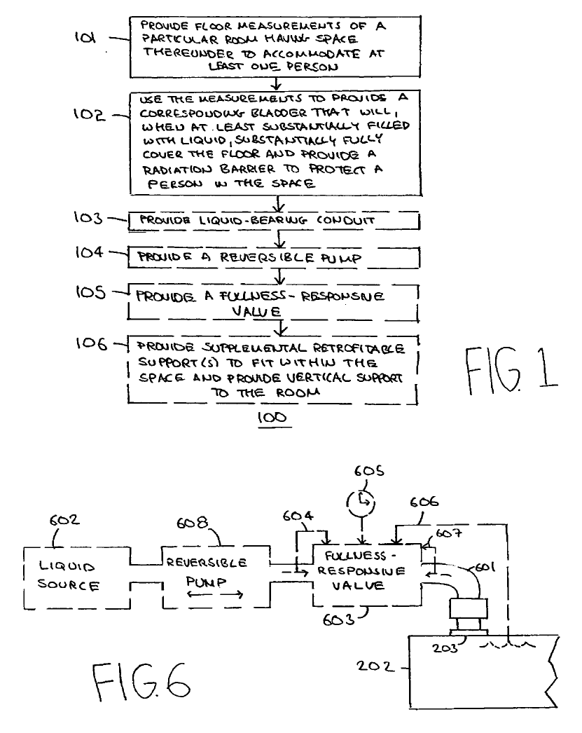

These and other benefits may become clearer upon making a thorough review and study of the following detailed description. Referring now to the drawings, and in particular to FIG. 1, a corresponding process 100 accommodates providing 101 measurements as correspond to a floor of a particular room. With momentary reference to FIG. 2, this room 201 can be of effectively any size and or shape and may further comprise, if desired, multiple levels (as where a first portion of the floor is raised by one step from another portion of the floor). In general, this floor 201 is effectively defined, at least in large part, by walls (not shown) that form the periphery of the floor 201. These teachings are also applicable for use with rooms that have one or more obstructions such as, but not limited to, columns, posts, and so forth.

The aforementioned measurements will typical comprise the measurements that relate to the peripheral dimensions of the room 201 (such as, for example, dimensions relating to length, width, and so forth). There are various ways to provide such measurements. By one approach, the property owner will provide such information (responding, for example, to corresponding instructions as may be provided by a bladder manufacturer or distributor). By another approach, a third party (such as a representative for the bladder manufacturer or distributor) can visit the property to obtain the room measurements. By yet another approach, such information may be of public or private record in some other obtainable fashion.

The room 201 in question can be essentially any room with one important caveat. This particular room (meaning at least some portion of this particular room though not necessarily the entire room) has space thereunder sufficient in size to accommodate at least one person. This space may be immediately adjacent to the room (as when the space comprises a basement and the room comprises a first floor room) or may be more remotely positioned (as when the space comprises a first floor room and the room comprises a third floor room).

Referring again to FIG. 1, this process 100 then provides for using 102 these measurements to provide a corresponding bladder that will, when at least substantially filled with liquid (such as, but not limited to, water) substantially fully cover the floor. This, in turn, will comprise a radiation barrier to thereby provide corresponding protection to a person (or other object) in the aforementioned space. With momentary reference again to FIG. 2, the resultant bladder 202 will therefore have a periphery that, at least when substantially filled, will substantially conform to the aforementioned room 201. In the illustrative example shown, the room 201 and the bladder 202 both have a corresponding L-shape to achieve this result.

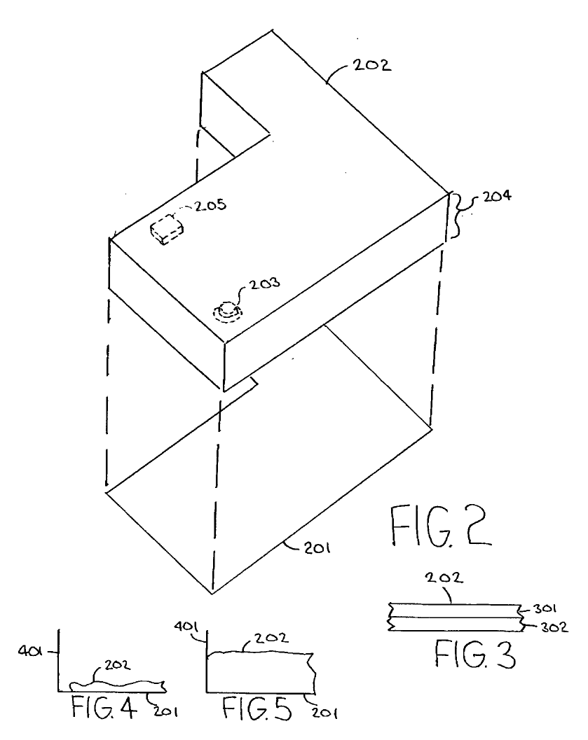

By one approach, this bladder 202 is comprised of a single layer of material (such as plastic, rubber, or the like). If desired, and particularly when seeking to imbue the bladder 202 with increased strength, the bladder 202 may be comprised of two or more layers of material. For example, and referring momentarily to FIG. 3, the bladder 202 may comprise a first layer 301 that is laminated to a second layer 302. These layers may comprise identical material or may comprise differing materials. For example, by one approach a first layer may be comprised of a flexible waterproof material and another layer may be comprised of a radiation-blocking fabric (such as, for example, Demron material (as is available from Radiation Shield Technologies)).

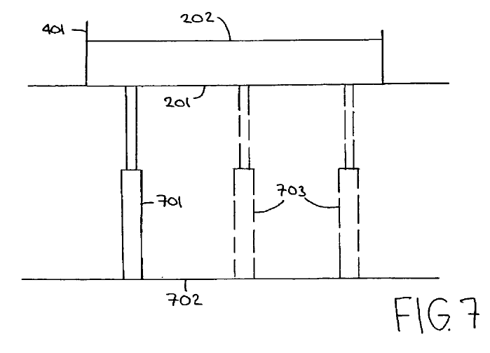

For many application settings it may be useful to form the bladder 202 using materials that exhibit elasticity. Elastic material, in turn, will permit the bladder 202, when at least substantially filled with liquid, to automatically become elongated to thereby facilitate substantially fully covering the floor. To illustrate, the bladder 202 can be deployed in an unfilled modality on the floor of a given room 201 as shown in FIG. 4 such that the bladder 202 does not contact a particular wall 401. Upon being at least substantially filled with liquid, however, the elastic material as comprises the bladder 202 can undergo sufficient elongation as illustrated in FIG. 5 to permit extension of the bladder 202 to effect a more complete degree of floor coverage.

Referring again to FIG. 2, the amount of radiation blockage offered by a particular bladder will relate in significant ways to the depth of the bladder 202 when filled. For many application purposes this depth 204 should be at least 10 inches and may be of considerably greater depth if desired. For example, by one approach, this depth 204 may comprise about 30 inches to provide a considerable amount of radiation blocking capability.

By one approach the sides of the bladder 202 are configured to preferably be relatively straight and vertical as suggested by the illustration provided in FIG. 2. This, in turn, may aid in facilitating a snug fit against the walls of the room and hence will encourage full coverage of the floor with the substantially full depth of the bladder 202. If desired, it would also be possible to provide a seam and/or piping along one or more of the edges of the bladder 202 (such as the piping that is typically provided along the edges of a mattress).

Watertight bladders of various kinds are known in the art and others are likely to be introduced in the future. As these teachings are not particularly sensitive to the selection of any particular choice in this regard, for the sake of clarity and brevity elaboration regarding the construction of the bladder beyond that already provided above will not be set forth here.

By one approach the bladder 202 will have at least one opening 203 formed therein to facilitate the passage of liquid. This opening may be of any size as suits the needs and/or requirements of a given application setting. In many cases it will be useful if the opening 203 comprises a selectively closeable opening (using, for example, threaded members as are known in the art) and, perhaps most preferably, a waterproof closeable opening. It may be desirable for some application purposes to provide a plurality of such openings to facilitate filling and/or emptying the bladder 202.

Other accoutrements may be added to the bladder 202 as desired to address particular needs, desires, and/or requirements. As but one illustrative example in this regard, the bladder 202 may further comprise a radiation exposure indicator 205 such as a dosimeter as is known in the art. Such an embellishment would permit a user to visually ascertain whether the bladder 202 had indeed been exposed to ionizing radiation during a period of deployment.

Referring again to FIG. 1, if desired, these teachings will also optionally accommodate providing 103 a length of liquid-bearing conduit that is operably coupleable to the aforementioned opening. Such a liquid-bearing conduit can serve, for example, to facilitate filling and/or emptying the bladder. To illustrate, and referring momentarily to FIG. 6, a given length of liquid-bearing conduit 601 can be provided that will serve to operably couple the bladder 202, via the aforementioned opening 203, to a liquid source 602. The liquid source 602 will of course vary from one application setting to another. Illustrative examples include water storage containers (such as water towers), portable water sources such as water container trucks and the like, and valved sources (such as water faucets) as are found in various residential, business, commercial, and industrial settings.

In many cases, one or more useful liquid sources may be identified at the time of acquiring the above-mentioned floor measurements. In such a case, this step may comprise, if desired, providing measurements as correspond to a relative planned position of the bladder in the room with respect to a particular source of liquid. This, in turn, would facilitate providing a liquid-bearing conduit that was of sufficient length to make the necessary connections. This would also facilitate, if desired, minimizing the length of the liquid-bearing conduit to no more than what might be adequate for the intended purpose.

Various liquid-bearing conduits are well known in the art. These include but are not limited to various hoses and tubes comprised of various materials including plastic, metal, ceramic, and so forth. The present teachings are not particularly sensitive to the selection of any particular approach in this regard.

Referring again to FIG. 1, this process 100 will also optionally permit provision 104 of a reversible pump as is known in the art to facilitate filling and/or emptying the bladder. With reference again to FIG. 6, such a reversible pump 608 could be placed in line, for example, with the aforementioned liquid-bearing conduit 601. So configured, this pump 608 could be selectively operated to facilitate pumping liquid towards the bladder 202 in order to fill the bladder 202. This pump 608 could also be selectively operated to facilitate pumping liquid out of the bladder 202 and towards a storage receptacle, drain, or the like to thereby facilitate emptying the bladder 202.

It may be useful to facilitate filling the bladder in an unsupervised manner. For example, an end user might wish to initiate the filling process and then remove themselves to the aforementioned space below the floor and bladder while the filling process continues. By one approach, an overflow mechanism can be provided to divert excess liquid away from the bladder and towards, for example, a drain, an exterior window or door, and so forth. So configured, when the bladder becomes filled any additional flowing liquid will be directed elsewhere to prevent, for example, damage to the floor that is supporting the bladder.

By another approach, it may be useful to automatically discontinue the filling process when, for example the bladder becomes sufficiently full. To facilitate such an action, and referring again to FIG. 1, this process 100 can optionally comprise providing a fullness-responsive valve. This fullness-responsive valve can be operably coupleable to the bladder opening and can serve to automatically limit the liquid as enters the bladder such that filling of the bladder to a useful level can be conducted in the absence of human supervision.

Various fullness-responsive valves and corresponding control systems are known. For example, and referring again momentarily to FIG. 6, the fullness-responsive valve 603 can be configured and arranged to monitor and respond to a total flow 604 of liquid therethrough. By knowing a priori, for example, that the bladder 202 can usefully contain 100 gallons of liquid, the flow rate of liquid into the bladder 202 can serve to calculate an amount of liquid that has been delivered to the bladder 202, which calculated amount can be compared against the known capacity value to trigger an appropriate switching action when a full level has been established.

By another approach, the fullness-responsive valve 603 can comprise a time sensitive valve and respond to a duration of time 605 during which the liquid flows into the bladder 202. By this approach, filling of the bladder 202 will conclude when a predetermined amount of time has passed. By yet another approach, the fullness-responsive valve 603 can comprise a level responsive valve that responds to a level of fluid 606 within the bladder 202. And by yet another approach, the fullness-responsive valve 603 can comprise a pressure sensitive valve that responds to pressure 607 within the bladder 202. These and other valve control mechanisms and strategies are well known in the art.

Liquids can represent a significant weight. Water, for example, weighs more than 64 pounds per square foot. It is therefore possible that the weight of the bladder, when substantially filled with a liquid of choice, will present a weight that exceeds the design specifications of the floor. With reference to FIG. 1, these teachings will therefore also optionally accommodate providing 106 a supplemental retrofitable support that is configured and arranged to fit within the aforementioned space and provide vertical support to the room to thereby aid in supporting the watertight bladder when latter is disposed in the room and filled with liquid.

With reference to FIG. 7, this supplemental retrofitable support 701 can serve, for example, to rest upon the floor 702 of the space and to translate that support to the aforementioned room floor 201. This supplemental retrofitable support 701 may comprise, for example, a telescoping supplemental retrofitable support 701. Such apparatus is known in the art and includes, for example, supports that telescopically extend by rotating one member with respect to another, by use of a jack, and so forth. Other approaches in this regard could also be considered if desired. It would also be possible, of course, to provide a plurality 703 of such supports to provide correspondingly increasing amounts of vertical supports.

By one approach, these supports could be retrofit to the space in question ahead of a time of need. By another approach, these supports could be fit into place in conjunction with deploying the bladder during a time of anticipated or actual need.

If desired, such a bladder can be deployed in conjunction with additional radiation blockage. For example, such a bladder could be deployed in a room above a radiation shelter that is disposed there under. An example of such a radiation shelter may be found at the previously mentioned patent application entitled RADIATION SHELTER KIT APPARATUS AND METHOD as filed on Apr. 24, 2006 and having application Ser. No. 11/379,929.

These teachings would accommodate, if desired, providing usage instructions along with the bladder to an end user. These instructions can describe, for example, the step-by-step actions that one takes to properly prepare a floor surface to receive the bladder and/or to properly place and fill the bladder. These instructions could also provide information regarding one or more ways to empty the bladder following usage.

If desired, one may provide one or more handles on the bladder to facilitate its movement during deployment, recovery, and so forth. It may also be appropriate to place one or more written or graphic notices on the bladder to caution the end user with respect to an appropriate side of the bladder to retain in an upwardly facing position and so forth.

Those skilled in the art will recognize and appreciate that these teachings provide for a highly flexible approach to providing effective, cost-effective, and discrete protection against radiation fallout. The unfilled bladder is readily transported and easily placed in a location of interest without requiring attention-grabbing conveyances, tools, or the like. The ability of these teachings to provide an effective degree of radiation blockage using only locally available tap water, of course, further underscores these benefits.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one example in this regard, the aforementioned measurements can pertain to two or more rooms (such as, but not limited to, adjoining rooms). Such measurements can then serve to guide provision of a single bladder that will substantially cover the floors of two or more rooms.

As another example in this regard, two or more deployed bladders can be coupled to one another by liquid-bearing conduits. So configured, a plurality of bladders can be filled using only a single point of introduction. This would facilitate, for example, unattended filling of multiple bladders during a time of need. As yet one more example in this regard, these teachings will readily accommodate vertical stacking of these bladders. By one approach, two or more such bladders as disposed directly atop one another. By another approach, a series of vertically juxtaposed rooms can each have such a bladder to thereby provide, in the aggregate, increased radiation blocking capability.

I claim:

1. A method comprising:
providing measurements as correspond to a floor of a particular room, which particular room has space thereunder sufficient to accommodate at least one person;
using the measurements to provide a corresponding bladder that will, when at least substantially filled with liquid, substantially fully cover the floor and provide a radiation barrier to thereby provide corresponding protection to a person in the space.

2. The method of claim 1 wherein using the measurements to provide a corresponding bladder comprises providing a bladder that is sized to provide a radiation barrier, when at least substantially filled with liquid, of at least ten inches in depth.

3. The method of claim 2 wherein providing a bladder that is sized to provide a radiation barrier, when at least substantially filled with liquid, of at least ten inches in depth comprises providing a bladder that is sized to provide a radiation barrier, when at least substantially filled with liquid, of at least thirty inches in depth.

4. The method of claim 1 wherein using the measurements to provide a corresponding bladder comprises providing a bladder that is formed, at least in part, of radiation-blocking fabric.

5. The method of claim 4 wherein providing a bladder that is formed, at least in part, of radiation-blocking fabric further comprises providing a bladder that is formed, at least in part, of:
radiation-blocking fabric;
flexible waterproof material.

6. The method of claim 1 wherein using the measurements to provide a corresponding bladder comprises providing a bladder having an opening formed therein to receive liquid therein.

7. The method of claim 6 further comprising:
providing a length of liquid-bearing conduit that is operably coupleable to the opening to facilitate filling the bladder with liquid.

8. The method of claim 7 wherein providing a length of liquid-bearing conduit further comprises providing measurements as correspond to a relative planned position of the bladder in the room with respect to a particular source of liquid.

9. The method of claim 6 further comprising:
providing a fullness-responsive valve that is operably coupleable to the opening to thereby automatically limit the liquid as enters the bladder such that filling of the bladder to a useful level can be conducted in an absence of human supervision.

10. The method of claim 9 wherein providing a fullness-responsive valve comprises providing at least one of:
a level responsive valve;
a flow quantity sensitive valve;
a time sensitive valve;
a pressure sensitive valve.

11. The method of claim 1 further comprising:
providing a supplemental retrofitable support that is configured and arranged to fit within the space and provide vertical support to the room to thereby aid in supporting the bladder when the bladder is disposed in the room and filled with liquid.

12. The method of claim 11 wherein providing a supplemental retrofitable support comprises using measurements regarding vertical space within the space to configure and arrange the supplemental retrofitable support.

13. The method of claim 11 wherein providing a supplemental retrofitable support comprises providing a telescoping supplemental retrofitable support.

14. The method of claim 1 wherein using the measurements to provide a corresponding bladder comprises providing a bladder formed, at least in part, of an elastic material such that the bladder will, when at least substantially filled with liquid, automatically become elongated to thereby facilitate substantially fully covering the floor.

15. The method of claim 1 wherein the liquid comprises water.

16. The method of claim 1 wherein using the measurements to provide a corresponding bladder comprises providing a bladder formed of at least two layers of material to thereby facilitate resistance to leakage.

17. The method of claim 1 wherein using the measurements to provide a corresponding bladder comprises providing a bladder that further comprises a radiation exposure indicator.

18. The method of claim 1 further comprising:
providing a reversible pump to facilitate filling and emptying the bladder.

19. A radiation-blocking apparatus comprising:
a watertight bladder that is configured and arranged to lie on the floor of and fit within and substantially conform to a particular room, which particular room has space thereunder sufficient to accommodate at least one person;
an opening disposed through the watertight bladder to facilitate receiving liquid therethrough such that the watertight bladder, when at least substantially filled with liquid, provides radiation-blocking protection for a person disposed in the space.

20. The radiation-blocking apparatus of claim 19 wherein the watertight bladder is sized to provide a radiation barrier, when at least substantially filled with liquid, of at least ten inches in depth.

21. The radiation-blocking apparatus of claim 20 wherein the watertight bladder is sized to provide a radiation barrier, when at least substantially filled with liquid, of at least thirty inches in depth.

22. The radiation-blocking apparatus of claim 19 further comprising:
radiation-blocking fabric disposed about at least a portion of the watertight bladder.

23. The radiation-blocking apparatus of claim 22 wherein the radiation-blocking fabric is disposed substantially about the entire watertight bladder.

24. The radiation-blocking apparatus of claim 19 wherein the watertight bladder is formed, at least in part, of flexible waterproof material.

25. The radiation-blocking apparatus of claim 19 further comprising:
a length of liquid-bearing conduit that is operably coupleable to the opening to facilitate filling the watertight bladder with liquid.

26. The radiation-blocking apparatus of claim 25 wherein the liquid-bearing conduit has a length that corresponds to a relative planned position of the watertight bladder in the room with respect to a particular source of liquid.

27. The radiation-blocking apparatus of claim 19 further comprising:
a fullness-responsive valve that is operably coupleable to the opening to thereby automatically limit the liquid as enters the watertight bladder such that filling of the watertight bladder to a useful level can be conducted in the absence of human supervision.

28. The radiation-blocking apparatus of claim 27 wherein the fullness-responsive valve comprises at least one of:
a level responsive valve;
a flow quantity sensitive valve;
a time sensitive valve;
a pressure sensitive valve.

29. The radiation-blocking apparatus of claim 19 further comprising:
a supplemental retrofitable support that is configured and arranged to fit within the space and provide vertical support to the room to thereby aid in supporting the watertight bladder when the watertight bladder is disposed in the room and filled with liquid.

30. The radiation-blocking apparatus of claim 29 wherein the supplemental retrofitable support comprises a telescoping supplemental retrofitable support.

31. The radiation-blocking apparatus of claim 19 wherein the watertight bladder comprises, at least in part, an elastic material such that the watertight bladder will, when at least substantially filled with liquid, automatically become elongated to thereby facilitate substantially fully covering the floor.

32. The radiation-blocking apparatus of claim 19 wherein the liquid comprises water.

33. The radiation-blocking apparatus of claim 19 the watertight bladder is comprised of at least two layers of material to thereby facilitate resisting leakage.

34. The radiation-blocking apparatus of claim 19 wherein the watertight bladder further comprises a radiation exposure indicator.

35. The radiation-blocking apparatus of claim 19 further comprising:
a reversible pump to facilitate filling and emptying the bladder.
